(19) United States
(12) Patent Application Publication
(10) Pub. No.: US 2026/0348660 A1
(43) Pub. Date: Nov. 5, 2026

(54) DRYING MAT FOR KITCHEN SINK

(71) Applicant: Karran USA, LLC, Vincennes, IN (US)

(72) Inventor: Todd Alexander, Vincennes, IN (US)

(21) Appl. No.: 19/666,917

(22) Filed: May 4, 2026

Related U.S. Application Data
(60) Provisional application No. 63/800,143, filed on May 5, 2025.

(51) Int. Cl. F26B 25/18

(52) U.S. Cl. CPC F26B 25/18

(57) ABSTRACT

A drying rack is configured to receive wet kitchen utensils and other objects and retain the objects over a kitchen sink while the objects dry. The drying rack includes a plurality of parallel bars and side supports. The plurality of parallel bars are spaced apart from one another and are designed to extend across the basin of a sink. The side supports include a first side support coupled to first ends of the plurality of parallel bars and a second side support coupled to opposite second ends of the parallel bars. Suction cups are coupled to the side supports and are configured to engage sink ledges and hold the drying rack in position over the sink. In at least one embodiment, the side supports include braces separated by flex joints.

### CROSS-REFERENCE TO RELATED APPLICATIONS

This patent application claims priority to United States Provisional Patent Application No. 63/800,143, filed May 5, 2025, the entire contents of which are incorporated by reference herein.

### FIELD

The present disclosure relates to sinks and particularly to accessories used in association with kitchen sinks.

### BACKGROUND

Drying mats for kitchen sinks are known. Drying mats are configured to be placed above the basin of a sink and support kitchen dishes, utensils, containers, accessories and other objects for drying. The drying mats extend across the upper perimeter of the sink and provide a platform to receive and support the kitchen dishes, utensils, containers, accessories, and other objects (which may be collectively referred to herein as “kitchen objects”). These drying mats typically include a series of equally spaced bars that are retained in place by side supports comprised of a flexible material (e.g., cured silicone or other polymer material). Spaces between the bars allow water from the kitchen objects to drip down into the sink during the drying process. The bars of drying rack may be comprised of any of various relatively rigid materials, such as metal, wood, plastic, or a combination thereof. The flexible supports maintain the position of the bars relative to one another when the drying mat is in use, but also allow the mat to be rolled up for convenient storage when not in use.

Unfortunately, a drying mat may not be as stable as desired by a user when the drying mat is located over a kitchen sink. Repeated placement of objects on the mat may cause the mat to shift over time. Moreover, accidental bumping of the mat may cause the mat to become dislodged from a desired position, resulting in the mat falling into the sink and/or objects falling from the mat. Accordingly, it would be advantageous to provide a kitchen drying mat that may be easily and conveniently positioned over a kitchen sink but is stable and maintains its position notwithstanding repeated placement of objects on the rack and bumping of the rack.

### SUMMARY

A kitchen drying rack is disclosed herein and is configured to receive kitchen objects. The kitchen drying rack includes a plurality of parallel bars and side supports. The plurality of parallel bars are spaced apart from one another. The side supports include a first side support coupled to first ends of the plurality of parallel bars and a second side support coupled to opposite second ends of the parallel bars. Suction cups are coupled to the side supports.

In at least one embodiment, a drying rack is used in a drying system for kitchen objects. The drying system includes a kitchen sink and the drying rack. The kitchen sink defines a basin and sink ledges on opposite sides of the basin. The drying rack is positioned over the basin of the kitchen sink. The drying rack includes a plurality of parallel bars spaced apart from one another and extending over the basin with the side supports engaging the sink ledges. The side supports include a first side support coupled to first ends of the plurality of parallel bars and a second side support coupled to opposite second ends of the parallel bars. A plurality of suction cups are coupled to the side supports.

In at least one embodiment, the drying rack is used in association with a method of drying objects in a kitchen. The method includes positioning a drying rack over a kitchen sink such that a plurality of parallel bars of the drying rack extend over a basin of the sink and side supports of the drying rack are positioned over opposing sink ledges. The method further includes forcing the drying rack downward such that suction cups arranged on a bottom side of the side supports achieve a negative fluid pressure in cavities of the suction cups, thus causing the suction cups to adhere to an engaging surface of the opposing sink ledges. Thereafter, the method includes placing at least one wet object on the parallel bars for drying.

### BRIEF DESCRIPTION OF THE DRAWINGS

FIG. 1 shows an upper perspective view of a drying mat for a kitchen sink with the drying mat in an expanded configuration;

FIG. 2 shows an upper perspective view of the drying mat of FIG. 1 in a partially rolled/collapsed configuration;

FIG. 3 shows a top view of the drying mat of FIG. 1;

FIG. 4 shows a bottom view of another embodiment of the drying mat of FIG. 1;

FIG. 5 shows an end view of the drying mat of FIG. 4;

FIG. 6 shows an enlarged side view of a side support of the drying mat of FIG. 4; and

FIG. 7 shows the drying mat of FIG. 1 positioned over a sink.

### DESCRIPTION

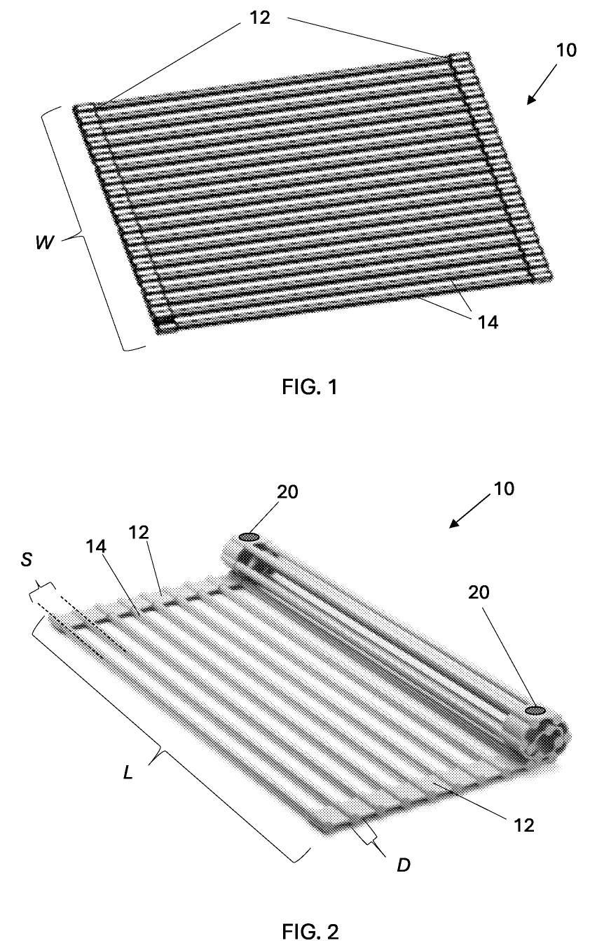

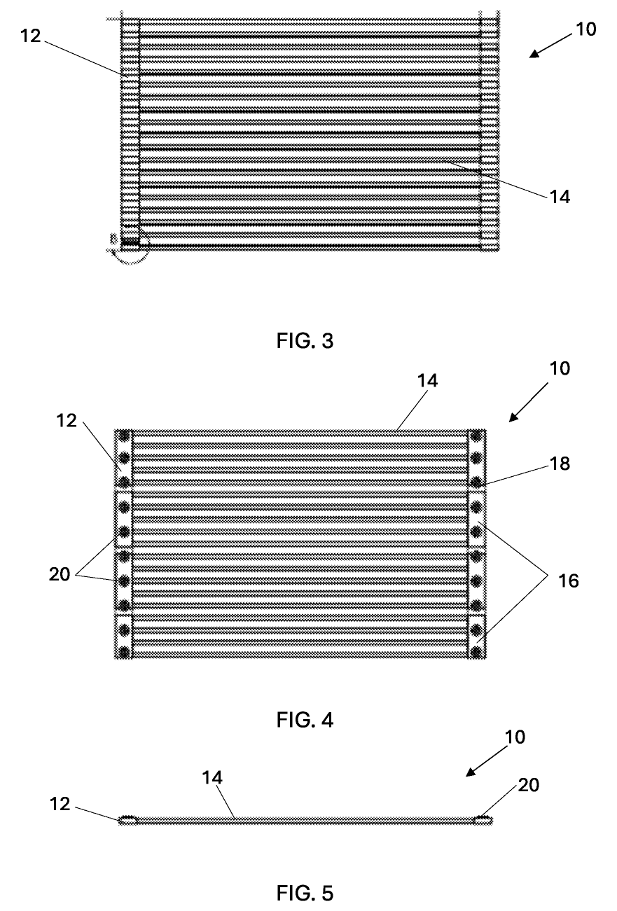

With reference now to FIGS. 1-3, a kitchen drying rack 10 is shown for use in association with a kitchen sink. The drying rack 10 (which may alternatively be referred to herein as a “drying mat”) includes two parallel side supports 12 and a plurality of parallel bars 14. Similar to a conventional drying rack, the side supports 12 may be comprised of a flexible material, and the parallel bars 14 may be comprised of a rigid material. Suction cups 20 are mounted to the bottom of the side supports to assist in retaining the drying rack in position over a sink basin.

The side supports 12 are elongated and positioned on opposite sides/edges of the drying rack 10. A first side support is on a first side of the drying rack 10 and a second side support is on an opposite second side of the drying rack 10. Each of the side supports 12 extend along a width W that is less than or equal to the associated width of a sink for which the drying rack 10 is configured for use (i.e., the distance across opposing edges of any number of conventional kitchen sinks as measured from side-to-side or front-to-back). As noted previously, the side supports 12 are comprised of a relatively flexible material (e.g., 1-20 MPa and/or 20A to 80A Shore), such as silicone or other synthetic or natural polymers. The flexible side supports allow the drying rack 10 to be rolled up and/or folded when not in use.

The parallel bars 14 extend perpendicularly between the side supports 12 on the drying rack 10. First ends of the parallel bars 14 are coupled to the first side support and second ends of the parallel bars 14 are coupled to the second side support. In at least one embodiment, the parallel bars 14 are coupled to the side supports by being embedded in the material that forms the side supports 12. The parallel bars 14 are elongated cylindrical members and may have any appropriate cross-sectional shape from end-to-end, such as round or rectangular cross-sectional shapes. The diameter/width of each bar is defined by a diameter D, as shown in FIG. 2. The length of each parallel bar is defined by a length L that is slightly greater than the length of the sink intended for use with the drying rack 10 (e.g., the length of any conventional kitchen sink as measured from front to back). In at least one embodiment, D is 10.5 mm and L is 520 mm +/- 2 mm, The parallel bars 14 may be equally spaced apart on the drying rack 10 at a spacing dimension of S. In at least one embodiment the spacing S is approximately 0.5 and 1.0 inches, such as about 11.5 mm. In at least one embodiment, the spacing between the parallel bars 14 is at least twice the diameter of each bar (i.e., S ≥ 2D). As a result, the distance between the sides of two adjacent parallel bars 14 is at least as great as the diameter of each parallel bar. As noted previously, the parallel bars 14 are comprised of a relatively stiff and strong material (e.g., 20-200 GPa). For example, in at least some embodiments, the parallel bars are comprised of a metal material (e.g., aluminum, steel, metal alloys, etc.), a wood material (e.g., maple, oak, etc.), or a plastic material (e.g., polycarbonate, acrylic, PVC, etc.).

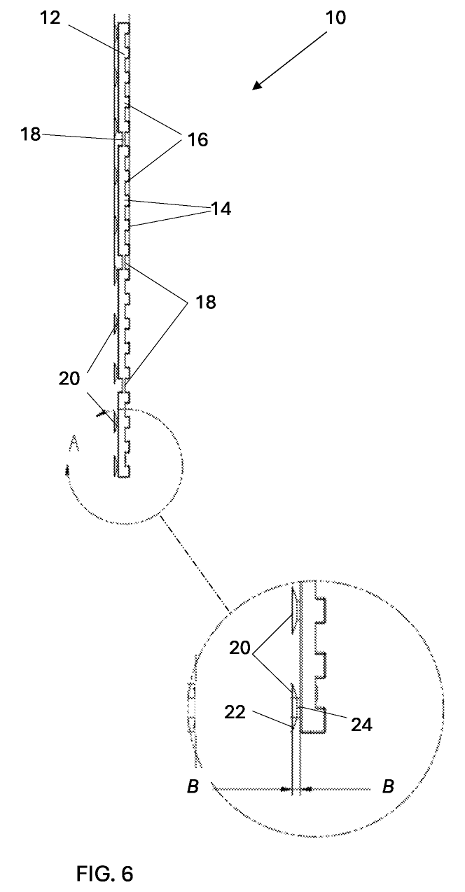

As best shown in FIGS. 2 and 4-6, a plurality of suction cups 20 are fixedly mounted along the bottom of the side supports 12. In at least one embodiment, the plurality of suction cups 20 are periodically and evenly spaced along each side support 12. Each suction cup 20 is defined by a cup structure 22 (or simply a “cup”) that extends outward from an integrally formed mount 24. Each cup 22 and mount 24 are comprised of a resilient, elastic, flexible, and pliable polymer material (e.g., silicone, nitrile rubber, polyurethane, or PVC). . Each cup 22 includes an inner working face that defines a cavity formed within the cup. In at least some embodiments, a rim of the cup 22 is a circular rim. The size of the cup 22 is relatively small. For example, the diameter of each cup 22 may be the same as or less than the distance S as the distance between the parallel bars 14. In at least one embodiment, the diameter of each cup 22 is between 9 mm and 12 mm. As shown in FIG. 6, each cup extends a distance B below the bottom surface of the drying rack. This distance may be, for example, 2 mm – 4 mm.

When an outer center portion of the suction cup 20 is pressed against a flat, non-porous surface (e.g., a kitchen countertop), the volume of the space between the suction cup 20 and the flat surface is reduced, which causes the air or water between the cup and the surface to be expelled past the rim of the circular cup. The cavity between the cup 22 and the flat surface then has little to no air or water in it because most of the fluid has already been forced out of the inside of the cup, causing a vacuum (or at least a reduced pressure cavity). The pressure difference between the atmosphere on the outside of the cup 22 and the low-pressure cavity on the inside of the cup keeps the cup adhered to the surface.

A weld, adhesive or other bond may be used to secure the suction cups 20 along the bottom surfaces of the side supports 12. The coupling of the suction cups 20 to the bottom surface of the side supports 12 is provided by a coupling between the mount 24 and the side support 12. This allows the cup portion of the suction cup 20 to freely flex and move relative to the side support 12 in order to achieve the desired low pressure cavity when in use. In at least one embodiment, the suction cups 20 are integrally formed with the side supports 12 and formed of the same material as the side supports 12. For example, the suction cups may be formed of a cured silicone or other polymer material that is the same material as the side supports 12. In such embodiment each side support 12 is a monolithic component with integrated suction cups.

As best shown in FIGS. 4 and 6, in at least one embodiment, the side supports 12 may be segmented into a plurality of sections with one or more suction cups 20 secured to each rigid section. For example, each side support 12 may include four distinct rigid braces 16 with flex joints provided between adjacent braces. Each rigid brace 16 is a relatively short bar structure (e.g., shorter than half the width W of the drying rack 10, and typically less than ¼ W). The bar structure is generally cylindrical with a consistent cross-sectional shape from end-to-end (e.g., a rectangular cross section). Each brace 16 is formed from a relatively stiff material, such as metal, wood or stiff plastic (e.g., similar to the material used for the parallel bars 14). The rigid braces 16 are completely covered by the relatively soft and pliable polymer material used in the side support 12 (e.g., embedded in the silicone material used for the side support 12). The soft and pliable material of the side support 12 extends between adjacent braces 16 and provides flex joints 18 for the side supports. Accordingly, in this embodiment, the drying rack 10 may be folded at the flex joints 18 in order to collapse the drying rack for storage (i.e., as opposed to continuously rolling the drying rack to collapse the drying rack as shown in FIG. 2). Folding at the flex joints 18 advantageously stacks the suction cups on one another (e.g., either facing one another or separated by one or more of the stacked braces 16). Stacking of the suction cups 20 in this matter prevents undue distortion of the suction cups 20 which could result when a side support without braces 16 is rolled up. Such distortion of the suction cups 20 during rolling of the drying rack 10 could cause the suction cups 20 to deform and become non-functional over time.

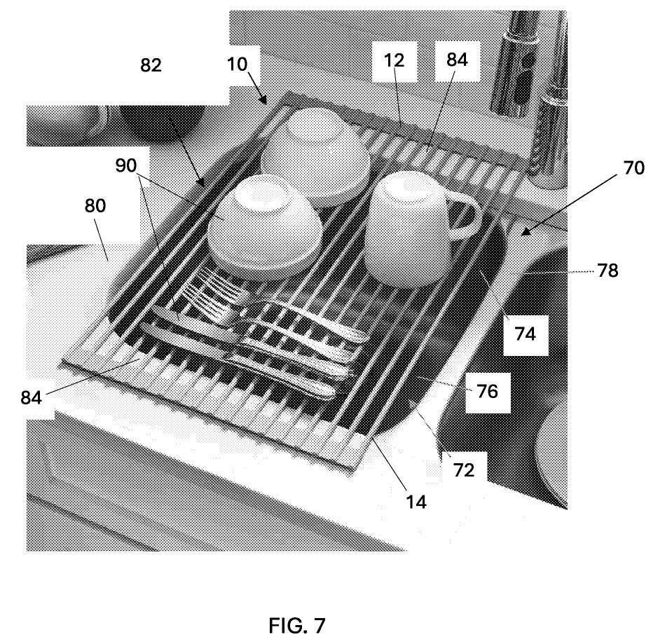

FIG. 7 shows the drying rack 10 when used with a kitchen sink 70 as part of a kitchen drying system. The kitchen sink 70 includes a basin 72 defined by sidewalls 74 and a sink floor 76. The sink is mounted in a kitchen countertop 80 with an opening 82 that exposes the sink basin 72. Sink ledges 84 surround the basin. The sink ledges 84 are surfaces that are substantially parallel to the sink floor 76. The sink ledges 84 may be defined by the kitchen countertop 80 or a rim 78 of the sink basin.

In order to use the drying rack 10, the user unfolds/unrolls the drying rack 10 from a collapsed position to an expanded position and extends the drying rack across the sink 70 with the suction cups 20 of the drying rack facing either the solid surface of the horizontal countertop 80 or a horizontal rim of the kitchen sink, similar to that shown in FIG. 7. The user then presses down on the side supports 12 of the drying rack 10 in order to force the suction cups 20 downward and achieve a negative fluid pressure in the cavity of at least some of the suction cups 20. The negative fluid pressure causes the suction cups 20 to adhere to the engaging surface of sink ledges 84 on the countertop (or shoulder/rim 78) of the kitchen sink 70. The grip provided by the suction cups 20 prevents the drying rack 10 from becoming easily dislodged or shifting during normal kitchen activities. However, the size of the suction cups is sufficiently small such that when a user is finished with the drying rack 10 the suction cups 20 may be easily pulled away from the associated kitchen surface. When pulling the suction cups 20 from the surface, the flex joints 18 between the braces 16 allow for the drying rack 10 to be released in sections (i.e., as defined by opposing braces). By releasing the drying rack 10 in sections, the user may more easily avoid a situation where all suction cups are simultaneously released from the sink ledges (e.g., if the entire side brace were stiff along its width, W), and the drying rack is forcefully pulled away from the sink ledge with too much momentum.

In view of the foregoing, it will be recognized that in at least one embodiment, the drying rack 10 is used in association with a method of drying objects in a kitchen. The method includes positioning a drying rack 10 over a kitchen sink 70 such that a plurality of parallel bars 14 of the drying rack extend over a basin 72 of the sink and side supports 12 of the drying rack 10 are positioned over opposing sink ledges 84. The method further includes forcing the drying rack 10 downward such that suction cups 20 arranged on a bottom side of the side supports 12 achieve a negative fluid pressure in cavities of the suction cups, thus causing the suction cups 20 to adhere to an engaging surface of the opposing sink ledges 84. Thereafter, the method includes placing at least one wet object 90 on the parallel bars 14 for drying. Specifically, wet objects may drip dry into the basin 72 of the sink.

Once the wet objects 90 have dried on the drying rack, they are removed from the parallel bars 14 of the drying rack 10 and returned to their proper place in the kitchen. Thereafter, the user may remove the drying rack 10 from the adhesion to the sink ledges 84 by sequentially releasing the suction cups from the sink ledges (e.g., releasing the suction cups in sections defined between the flex joints, as discussed previously herein). Thereafter, the drying rack 10 may be rolled or folded for storage.

Although the various embodiments of the drying rack have been provided herein, it will be appreciated by those of skill in the art that other implementations and adaptations are possible. For example, in at least some embodiments, the drying may be differently configured, such as designed and dimensioned to rest on the sink floor rather than on the sink ledges. In other embodiments, different materials may be used in the various components of the drying rack. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

1. A kitchen drying rack configured to receive kitchen objects, the kitchen drying rack comprising:
a plurality of parallel bars spaced apart from one another;
side supports including a first side support coupled to first ends of the plurality of parallel bars and a second side support coupled to opposite second ends of the parallel bars; and
a plurality of suction cups coupled to the side supports.

2. The kitchen drying rack of claim 1 wherein the plurality of suction cups include a first plurality of suction cups coupled to the first side support and a second plurality of side suction cups coupled to the second side support.

3. The kitchen drying rack of claim 2 wherein the first side support is segmented into a plurality of braces and at least one flex joint, wherein adjacent braces of the plurality of braces are separated by a flex joint positioned between the adjacent braces.

4. The kitchen drying rack of claim 3 wherein each of the plurality of braces includes a rigid bar coupled to at least two of the plurality of parallel bars.

5. The kitchen drying rack of claim 4 wherein the rigid bar is integrally formed with the at least two of the parallel bars.

6. The kitchen drying rack of claim 4 wherein the rigid bar is arranged perpendicular to the at least two of the plurality of parallel bars.

7. The kitchen drying rack of claim 4 wherein the first side support includes a flexible polymer encasing each of the plurality of rigid braces and extending between each of the plurality of rigid braces, the flexible polymer providing the flex joint between the adjacent braces.

8. The kitchen drying rack of claim 4 wherein the second side support is also segmented into a plurality of braces and at least one flex joint, wherein adjacent brace of the plurality of braces are separated by a flex joint positioned between the adjacent braces, and wherein each of the plurality of braces includes a rigid bar coupled to at least two of the plurality of parallel bars.

9. The kitchen drying rack of claim 4 wherein the at least two of the plurality of parallel bars are coupled to a first side of the brace and at least one of the plurality of suction cups is coupled to the side support on an opposite second side of the brace.

10. The kitchen drying rack of claim 4 wherein the flex joint separates the adjacent braces by a distance at least as great as a width of the side supports.

11. A drying system for kitchen objects comprising:
a kitchen sink defining a basin and sink ledges on opposite sides of the basin; and
a drying rack positioned over the basin of the kitchen sink, the drying rack comprising:
a plurality of parallel bars spaced apart from one another and extending over the basin;
side supports engaging the sink ledges, the side supports include a first side support coupled to first ends of the plurality of parallel bars and a second side support coupled to opposite second ends of the parallel bars; and
a plurality of suction cups coupled to the side supports.

12. The drying system of claim 11 wherein the sink ledges are defined on a kitchen countertop in which the sink is mounted.

13. The drying system of claim 12 wherein the plurality of suction cups engage the kitchen countertop.

14. The drying system of claim 13 wherein the plurality of suction cups include a first plurality of suction cups coupled to the first side support and a second plurality of suction cups coupled to the second side support.

15. The drying system of claim 14 wherein the first side support is segmented into a plurality of braces and at least one flex joint, wherein adjacent braces of the plurality of braces are separated by a flex joint positioned between the adjacent braces.

16. The drying system of claim 15 wherein each of the plurality of braces includes a rigid bar coupled to at least two of the plurality of parallel bars.

17. A method of drying objects in a kitchen, the method comprising:
positioning a drying rack over a sink such that a plurality of parallel bars of the drying rack extend over a basin of the sink, and side supports of the drying rack are positioned over opposing sink ledges;
forcing the drying rack downward such that suction cups arranged on a bottom side of the side supports achieve a negative fluid pressure in cavities of the suction cups, thus causing the suction cups to adhere to an engaging surface of the opposing sink ledges; and
placing at least one wet object on the parallel bars for drying.

18. The method of claim 17 wherein the opposing sink ledges are provided on a countertop in which the sink is mounted.

19. The method of claim 17 wherein the side supports are segmented into a plurality of braces separated by a plurality of flex joints.

20. The method of claim 19 further comprising, after the at least one object has dried, removing the object from the parallel bars, releasing the drying rack from the opposing sink ledges, and folding the drying rack at the plurality of flex joints.
